(19) United States
(12) Patent Application Publication
(10) Pub. No.: US 2011/0153570 A1
(43) Pub. Date: Jun. 23, 2011

(54) DATA REPLICATION AND RECOVERY METHOD IN ASYMMETRIC CLUSTERED DISTRIBUTED FILE SYSTEM

(75) Inventor: Young-Chul KIM, Daejeon (KR)

(73) Assignee: Electronics and telecommunications Research Institute, Daejeon-city (KR)

(21) Appl. No.: 12/971,759

(22) Filed: Dec. 17, 2010

(30) Foreign Application Priority Data
Dec. 18, 2009 (KR) 10-2009-0127071
Mar. 3, 2010 (KR) 10-2010-0018862

(51) Int. Cl. G06F 12/16; G06F 17/30

(52) U.S. Cl. 707/652; 707/674; 707/E17.005

(57) ABSTRACT

Disclosed herein is data replication and recovery method in an asymmetric clustered distributed file system, which divides the storage space of a data server into main partitions and sub-partitions, and separately manages main chunks and sub-chunks in the main partitions and the sub-partitions, thus efficiently processing chunk replication and recovery. In the disclosed method, when a failure occurs in a data server in an asymmetric clustered distributed file system, a failed partition is reported to all data servers including other partitions of a volume to which the partitions of the failed data server belong. Accordingly, other data servers can simultaneously perform the recovery of chunks using the information of their own main chunks and sub-chunks. As a result, when a failure occurs in a data server, all related data servers can simultaneously participate in data recovery, thus more promptly and efficiently coping with the failure.

### CROSS REFERENCE TO RELATED APPLICATIONS

This application claims the benefit of Korean Patent Application Nos. 10-2009-0127071 filed on Dec. 18, 2009 and 10-2010-0018862 filed on Mar. 3, 2010, in Korean Intellectual Property Office, which are hereby incorporated by reference in their entirety into this application.

### BACKGROUND OF THE INVENTION

1. Field of the Invention

The present invention relates, in general, to a data replication and recovery method in an asymmetric clustered distributed file system, and, more particularly, to a method of replicating and recovering data from the failure of a data server in an asymmetric clustered distributed file system.

2. Description of the Related Art

An asymmetric clustered distributed file system is a system for separating the metadata and actual data of a file from each other and separately storing and managing the metadata and the actual data.

Typically, metadata is data describing other data and is also called “attribute information.”

Such metadata is managed by a metadata server. Actual data is distributed to and stored in a plurality of data servers. Metadata contains information about data servers in which the actual data is stored. The metadata server and the plurality of data servers are connected to each other over a network and have a distributed structure.

Therefore, paths along which a client accesses the metadata and the actual data of a file are separate. That is, in order to access a file, the client primarily accesses the metadata of the file stored in the metadata server and then obtains information about the plurality of data servers in which the actual data is stored. Thereafter, the input/output of the actual data is performed by the plurality of data servers.

An asymmetric clustered distributed file system divides file data into a plurality of data chunks having a fixed size, and distributes and stores the data chunks in a plurality of data servers.

Meanwhile, when a server or a network fails and goes down, the input/output of data cannot be performed. In order to solve this, replicas of data chunks in each data server needs to be made and are then to be stored in other data servers. In the case of replicas, in general, about three replicas are made and retained in consideration of storage expenses or the like. Replicas are retained in a plurality of data servers, thereby forming the advantage of allowing the access loads from clients to be distributed.

However, when the occurrence of the failure of a data server is detected, there must be a preset number of replicas of data chunks stored in the failed data server. Otherwise, when a continuous failure occurs in the data server, a client may not access data chunks.

In this way, the recovery of a failed data server must be performed along with tracing information about data chunks that were stored in the failed data server. As a result, a lot of expense is incurred. Further, since this operation is mainly performed by a metadata server, the load thereof may greatly influence other operations of the metadata server.

Therefore, a method of more efficiently and promptly performing the operation of recovering the failure of a data server is required.

### SUMMARY OF THE INVENTION

Accordingly, the present invention has been made keeping in mind the above problems occurring in the prior art, and an object of the present invention is to provide a data replication and recovery method in an asymmetric clustered distributed file system, which divides the storage space of a data server into main partitions and sub-partitions, and separately manages main chunks and sub-chunks in the main partitions and the sub-partitions, thus efficiently processing chunk replication and recovery.

Another object of the present invention is to more promptly and effectively recover data when the failure of a data server is detected in an asymmetric clustered distributed file system.

A further object of the present invention is to efficiently use a storage space in such a way that a metadata server divides the partitions, included in each volume, into partitions for respective data servers while managing the storage space on a volume basis.

Yet another object of the present invention is to enable all data servers related to a failed data server to simultaneously recover data by requesting the recovery of main partition information or sub-partition information in the data server, the failure of which has been detected, from data servers which store related main partitions or sub-partitions.

In accordance with an aspect of the present invention to accomplish the above objects, there is provided a data replication method in an asymmetric clustered distributed file system, including storing data received from a client in a relevant main chunk, using a first data server which includes a main partition having the main chunk; transmitting data stored in the main chunk to a second data server which includes a sub-partition having a sub-chunk corresponding to the main chunk, using the first data server; and replicating the received data to the sub-chunk, using the second data server.

Preferably, the first data server may be divided into the main partition and a sub-partition corresponding to a main partition of the second data server.

Preferably, the first data server may include a main partition chunk table for managing information about a sub-chunk corresponding to the main chunk stored in the main partition, and a sub-partition chunk table for managing information about a main chunk corresponding to a sub-chunk stored in the sub-partition.

Preferably, each of the main partition chunk table and the sub-partition chunk table may include a partition identifier and a chunk identifier. In this case, the partition identifier may be a unique value assigned by a metadata server. The chunk identifier may be allocated by a metadata server, and may include a file identifier of a file including a relevant chunk and an offset indicating an ordinal position of the relevant chunk within the file.

Preferably, the second data server may be divided into the sub-partition and a main partition having a main chunk differing from the main chunk of the first data server.

Preferably, the second data server may include a plurality of data servers.

Preferably, the data replication method may further include transmitting information about the main chunk to the client using the first data server, as the main chunk is initially allocated by a metadata server.

Preferably, the transmitting the main chunk information may include registering the main chunk information in a main partition chunk table of the first data server.

Preferably, the metadata server may divide and manage an entire storage space on a volume basis so that, for each volume, a storage space of each of the first and second data servers is divided into a plurality of partitions.

The plurality of partitions divided for each volume may include a main partition for storing a main chunk and a sub-partition corresponding to a main partition of another data server, for each of the first and second data servers.

Preferably, the data replication method may further include transmitting information about the sub-chunk corresponding to the main chunk to the first data server using the second data server, as the sub-chunk is initially allocated by the metadata server.

Preferably, the transmitting the sub-chunk information may include registering the sub-chunk information in a sub-partition chunk table of the second data server.

Preferably, the data replication method may further include when data is added to the main chunk or when data of the main chunk is updated, transmitting data identical to the added or updated data to the second data server, using the first data server; and replicating the received data to the sub-chunk of the sub-partition using the second data server.

In accordance with another aspect of the present invention to accomplish the above objects, there is provided a data recovery method in an asymmetric clustered distributed file system, including replicating a sub-chunk of a sub-partition corresponding to a main partition of a failed data server to another data server, using a first data server which includes the sub-partition; and replicating a main chunk of a main partition corresponding to the sub-partition of the failed data server to another data server, using a second data server which includes the main partition.

Preferably, the sub-chunk of the sub-partition may have a partition identifier identical to a main partition identifier of the failed data server.

Preferably, the main chunk of the main partition may have a partition identifier identical to a sub-partition identifier of the failed data server.

Preferably, the replicating the main chunk may be configured to replicate the main chunk to other data servers until the number of replicas of the main chunk is identical to a preset number of replicas.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the schematic construction of an asymmetric clustered distributed file system to which the present invention is applied;

FIG. 2 is a diagram schematically showing the case where the entire storage space of the asymmetric clustered distributed file system is divided and managed on a volume basis by the metadata server of the file system according to an embodiment of the present invention;

FIG. 3 is a diagram schematically showing the configuration of partitions in each data server of the asymmetric clustered distributed file system according to an embodiment of the present invention;

FIG. 4 is a diagram showing the management of main partition information and corresponding sub-partition information in the data server of the asymmetric clustered distributed file system according to an embodiment of the present invention;

FIG. 5 is a diagram schematically showing the structure of a table for managing chunk information stored in the main partition and the sub-partitions of FIG. 4;

FIG. 6 is a flowchart showing a data replication method in the asymmetric clustered distributed file system according to an embodiment of the present invention; and

FIG. 7 is a flowchart showing a data recovery method in the asymmetric clustered distributed file system according to an embodiment of the present invention.

### DESCRIPTION OF THE PREFERRED EMBODIMENTS

Hereinafter, embodiments of a data replication and recovery method in an asymmetric clustered distributed file system according to the present invention will be described in detail with reference to the attached drawings. The terms and words used in the present specification and the accompanying claims should not be limitedly interpreted as having their common meanings or those found in dictionaries. Therefore, the embodiments described in the present specification and constructions shown in the drawings are only the most preferable embodiments of the present invention, and are not representative of the entire technical spirit of the present invention. Accordingly, it should be understood that various equivalents and modifications capable of replacing the embodiments and constructions of the present invention might be present at the time at which the present invention was filed.

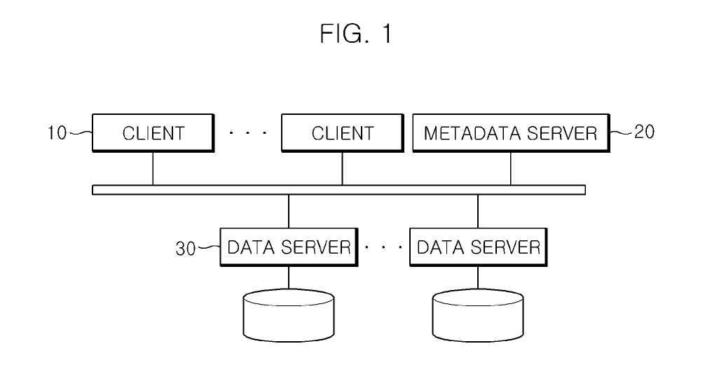

FIG. 1 is a diagram showing the schematic construction of an asymmetric clustered distributed file system according to the present invention.

The asymmetric clustered distributed file system of FIG. 1 includes clients 10, a metadata server 20, and data servers 30.

Each client 10 executes client applications. The client 10 accesses the metadata of each file stored in the metadata server 20. The client 10 inputs and outputs the data of the file stored in each data server 30.

The metadata server 20 stores and manages metadata about all the files of the file system. The metadata server 20 manages information about the status of all the data servers 30.

Each data server 30 stores and manages data chunks of files. The data server 30 periodically reports its status information to the metadata server 20. The data server 30 may preferably be implemented as a plurality of data servers.

The clients 10, the metadata server 20, and the plurality of data servers 30 are mutually connected over a network.

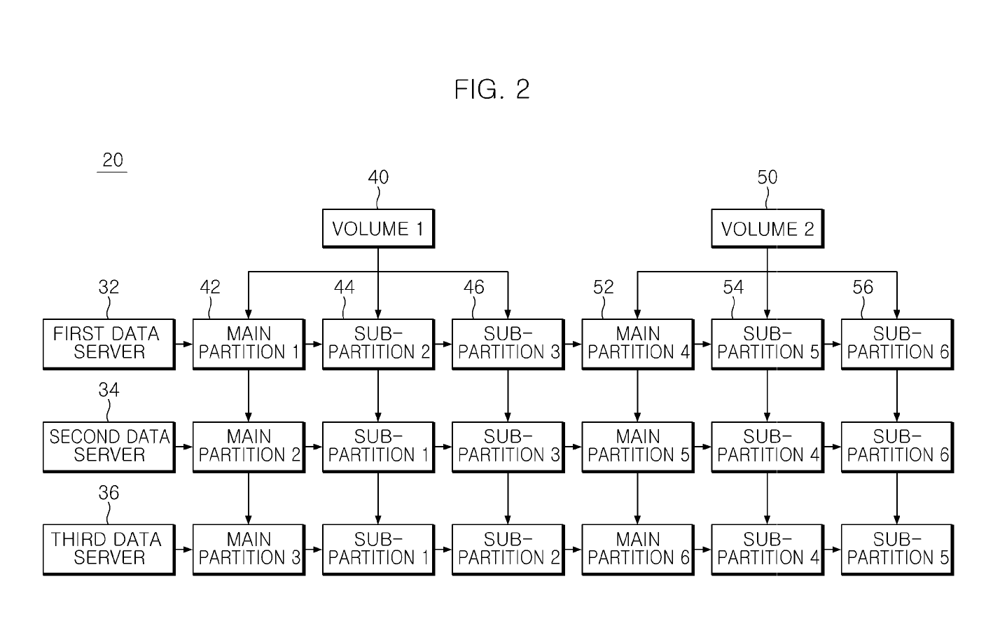

FIG. 2 is a diagram schematically showing the case where the entire storage space of the asymmetric clustered distributed file system is divided and managed on a volume basis by the metadata server of the file system according to an embodiment of the present invention.

The metadata server 20 divides the storage space of each of the first, second and third data servers 32, 34 and 36 in which file data is stored into a plurality of partitions 42, 44, 46, 52, 54, and 56, and manages the partitions in volumes 40 and 50 in which partitions are gathered. The client 10 is mounted on a volume basis, and then accesses the file system. The first, second and third servers 32, 34 and 36 of FIG. 2 may be regarded as the same components as the data server 30 of FIG. 1 with different reference numerals.

Each of the volumes 40 and 50 is composed of one or more partitions. In FIG. 2, the volume 40 is composed of one main partition 42 and a plurality of sub-partitions 44 and 46 for each data server. The volume 50 is composed of one main partition 52 and a plurality of sub-partitions 54 and 56 for each data server. The partitions are not shared among different volumes.

The main partitions 42 and 52 store main chunks. The sub-partitions 44, 46, 54, and 56 store sub-chunks which are replicas of the main chunks.

Consequently, each of the volumes 40 and 50 is composed of a plurality of main partitions and sub-partitions corresponding to each main partition. However, each of the main partitions 42 and 52 of the volumes 40 and 50 cannot exist as two or more main partitions on the same server. That is, per data server, only one main partition 42 and one main partition 52 respectively included in the volumes 40 and 50 may exist. One data server may have only one sub-partition corresponding to the main partition of each of other data servers. For example, the first data server 32 includes sub-partition 2 corresponding to the main partition 2 of the second data server 34, and sub-partition 3 corresponding to the main partition 3 of the third data server 36. This construction is required in order to uniformly allocate chunks to a plurality of data servers and to uniformly perform write operations using a plurality of data servers because main chunks are allocated only to main partitions, and write operations are performed only on main chunks.

As described above, the metadata server 20 has the main partitions 42 and 52 and the sub-partitions 44, 46, 54 and 56 allocated to one or more volumes for each of the first, second and third data servers 32, 34 and 36. In other words, the metadata server 20 divides the storage space of each of the plurality of data servers 32, 34 and 36 into a plurality of partitions, and manages the partitions on a volume basis, wherein the volume is a set of a plurality of gathered partitions. In addition, for each volume, the metadata server 20 includes one main partition per data server and a plurality of sub-partitions corresponding to main partitions of other data servers.

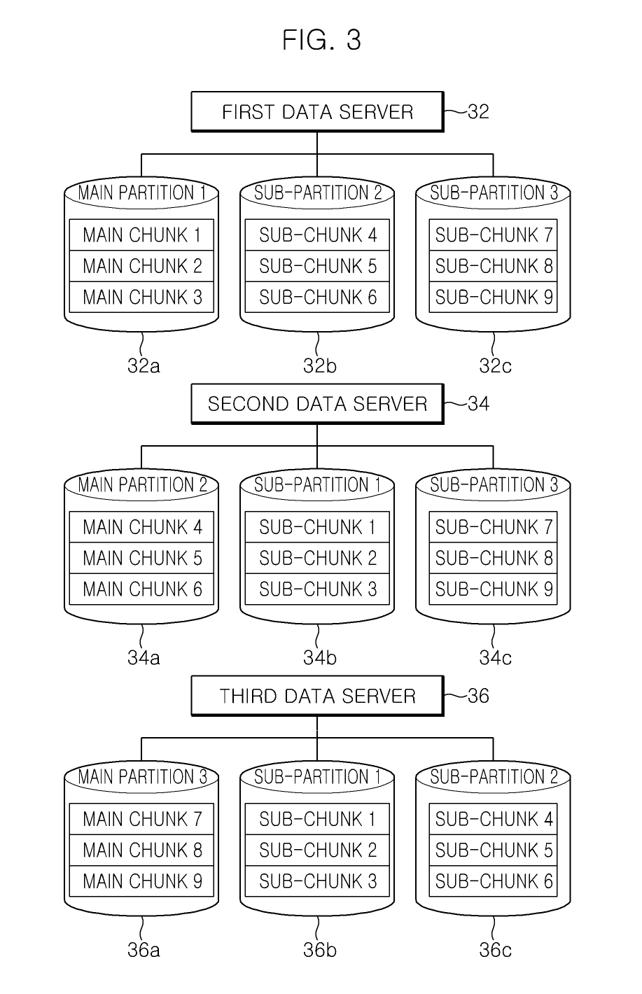

FIG. 3 is a diagram schematically showing the configuration of partitions in each data server of the asymmetric clustered distributed file system according to an embodiment of the present invention.

The storage space of each of the first, second and third data servers 32, 34 and 36 is divided into one main partition and a plurality of sub-partitions. For example, the storage space of the first data server 32 is divided into main partition 1 32a and sub-partitions 2 and 3 32b and 32c. The storage space of the second data server 34 is divided into main partition 2 34a and sub-partitions 1 and 3 34b and 34c. The storage space of the third data server 36 is divided into main partition 3 36a and sub-partitions 1 and 2 36b and 36c.

Each of the main partitions 1, 2 and 3 32a, 34a, and 36a stores main chunks.

The sub-partitions 1, 2, and 3 32b, 32c, 34b, 34c, 36b, and 36c store sub-chunks which are replicas of the main chunks stored in the main partitions 1, 2 and 3 32a, 34a, and 36a. For example, the sub-partitions 1 34b and 36b store sub-chunks (that is, sub-chunk 1, sub-chunk 2, and sub-chunk 3) which are replicas of main chunks stored in the main partition 1 32a (that is, main chunk 1, main chunk 2, and main chunk 3). The sub-partitions 2 32b and 36c store sub-chunks (that is, sub-chunk 4, sub-chunk 5, and sub-chunk 6) which are replicas of main chunks stored in the main partition 2 34a (that is, main chunk 4, main chunk 5, and main chunk 6). Further, the sub-partitions 3 32c and 34c store sub-chunks (that is, sub-chunk 7, sub-chunk 8, and sub-chunk 9) which are replicas of main chunks stored in the main partition 3 36a (that is, main chunk 7, main chunk 8, and main chunk 9).

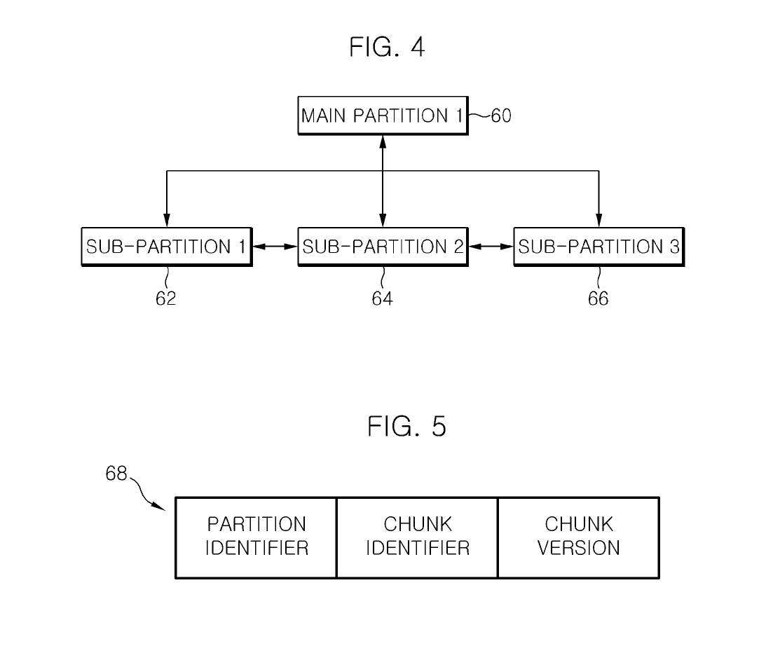

FIG. 4 is a diagram showing the management of main partition information and corresponding sub-partition information in the data server of the asymmetric clustered distributed file system according to an embodiment of the present invention. FIG. 5 is a diagram schematically showing the structure of a table for managing chunk information stored in the main partition and the sub-partitions of FIG. 4. The difference between FIG. 3 and FIG. 4 is that the storage space of the data server is assumed to be divided into one main partition and three sub-partitions in FIG. 4. Further, although reference numerals of the main partition and sub-partitions of FIG. 4 are different from those of FIG. 3, the corresponding components of FIGS. 3 and 4 are preferably regarded as identical components.

For each volume, the data server includes only one main partition 60. The data server manages information about the main partition 60 and sub-partitions 62, 64, and 66. In this case, the sub-partitions 62, 64, and 66 denote sub-partitions corresponding to the main partitions of other data servers.

Meanwhile, as shown in FIG. 5, the data server includes a chunk table 68 (that is, a main partition chunk table and a sub-partition chunk table) having information about chunks stored in the partitions.

The main partition chunk table manages information about sub-chunks corresponding to the main chunks stored in the main partition. Here, the sub-chunks are stored in other sub-partitions corresponding to the main partition.

The sub-partition chunk table manages information about main chunks corresponding to sub-chunks stored in the sub-partitions. Here, the main chunks are stored in the main partitions of other data servers.

Each of the main partition chunk table and the sub-partition chunk table includes a partition identifier, a chunk identifier, and chunk version information (refer to FIG. 5). The partition identifier is a unique value assigned by the metadata server. The chunk identifier is a value allocated by the metadata server, and is composed of the file identifier of a file including chunks and an offset indicating the ordinal position of each chunk within the file. Therefore, the chunk identifier has a unique value. Further, the identifier of a main chunk and the identifier of a sub-chunk that is a replica of the main chunk, have the same value. Therefore, in each partition, a chunk is identified by a partition identifier and a chunk identifier.

In this way, the chunk table 68 manages the chunk information of other data servers, related to main chunks or sub-chunks stored in a relevant data server. Accordingly, the chunk table 68 can efficiently search for and process chunk information related to a failed data server during a recovery process performed due to the failure of the data server. The insertion of chunk information into the chunk table 68 is performed at the time point at which a relevant chunk is replicated.

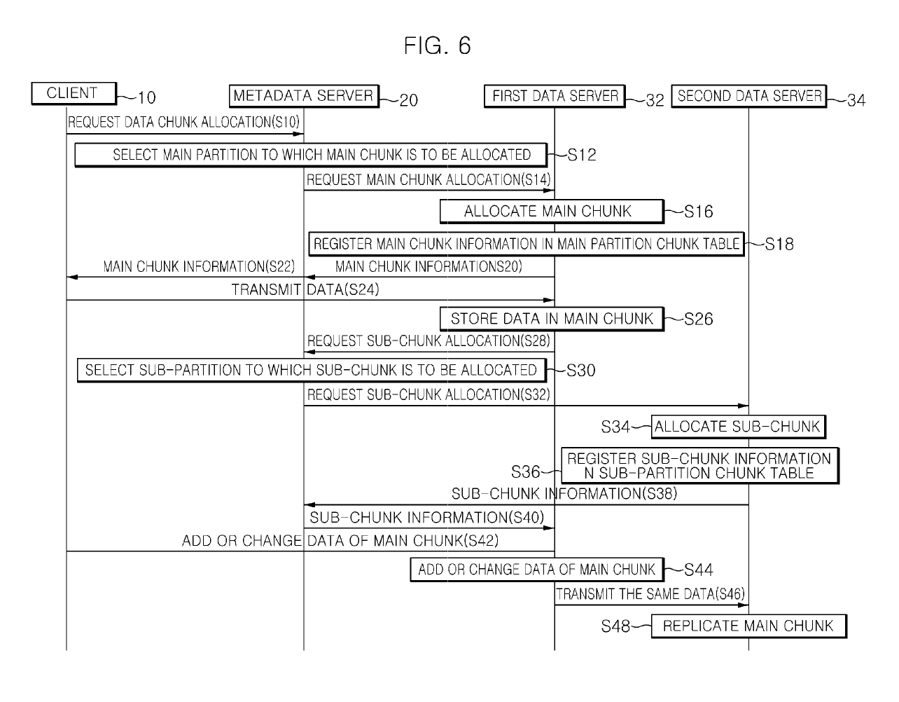

FIG. 6 is a flowchart showing a data replication method in the asymmetric clustered distributed file system according to an embodiment of the present invention. In other words, FIG. 6 illustrates a flowchart showing a process for allocating and replicating data chunks in the asymmetric clustered distributed file system to which the present invention is applied.

Before storing data in a file, the client 10 first requests the metadata server 20 to allocate a data chunk at step S10.

When the data chunk is a chunk to be allocated first, the metadata server 20 selects a main partition to which the main chunk is to be allocated at step S12.

The metadata server 20 requests a data server including the selected main partition (for example, the first data server 32) to allocate the main chunk at step S14.

The first data server 32 that received the request for the allocation of the main chunk allocates a main chunk to the main partition at step S16.

Further, the first data server 32 registers information about the allocated main chunk in the main partition chunk table at step S18.

The first data server 32 transmits information about the allocated main chunk to the client 10 via the metadata server 20 at steps S20 and S22.

Thereafter, the client 10 transmits data to the first data server 32 which stores the allocated main chunk so as to write file data at step S24.

The first data server 32 stores the data received from the client 10 in the main chunk at step S26.

In this case, when a sub-chunk which is a replica of the main chunk is not present, the first data server 32 requests the metadata server 20 to allocate a sub-chunk at step S28.

Accordingly, the metadata server 20 selects a sub-partition to which the sub-chunk is to be allocated at step S30.

Further, the metadata server 20 requests a data server including the selected sub-partition (for example, the second data server 34) to allocate a sub-chunk at step S32. In this case, although only one second data server 34 is exemplified, the data server including the selected sub-partition may be a plurality of data servers.

The second data server 34 that received the request for the allocation of the sub-chunk allocates a sub-chunk to the relevant sub-partition at step S34.

Further, the second data server 34 inserts information about the sub-chunk into the sub-partition chunk table at step S36.

Thereafter, the second data server 34 transmits the information about the sub-chunk to the metadata server 20 at step S38.

The metadata server 20 transmits the received sub-chunk information to the first data server 32 which stores the main chunk at step S40.

Therefore, when the client 10 desires to add data to the main chunk of the first data server 32 or change data in the main chunk at step S42, data is added to the main chunk of the first data server 32, or the data of the main chunk is changed at step S44.

Then, the first data server 32 transfers the same data as the data that was added or changed to the second data server 34 which includes the sub-chunk corresponding to the main chunk at step S46.

Accordingly, the second data server 34 replicates the received data to the sub-chunk, and thus completes the replication of the main chunk at step S48. In this case, the data is transferred to the file system on a block basis or on a page basis, thus preventing data from being read prior to being written at the time of overwriting the data.

Meanwhile, when the main chunk in which the client 10 desires to store data is already known, operations corresponding to the above steps S10 to S22 are not required. Further, when a sub-chunk which is a replica of the main chunk is present, operations at the above steps S28 to S40 are not required. Accordingly, when the main chunk in which the client 10 desires to store data is already known, the same data as the data stored in the main chunk of the relevant data server is replicated to a corresponding sub-chunk of another data server immediately after the data has been stored in the main chunk.

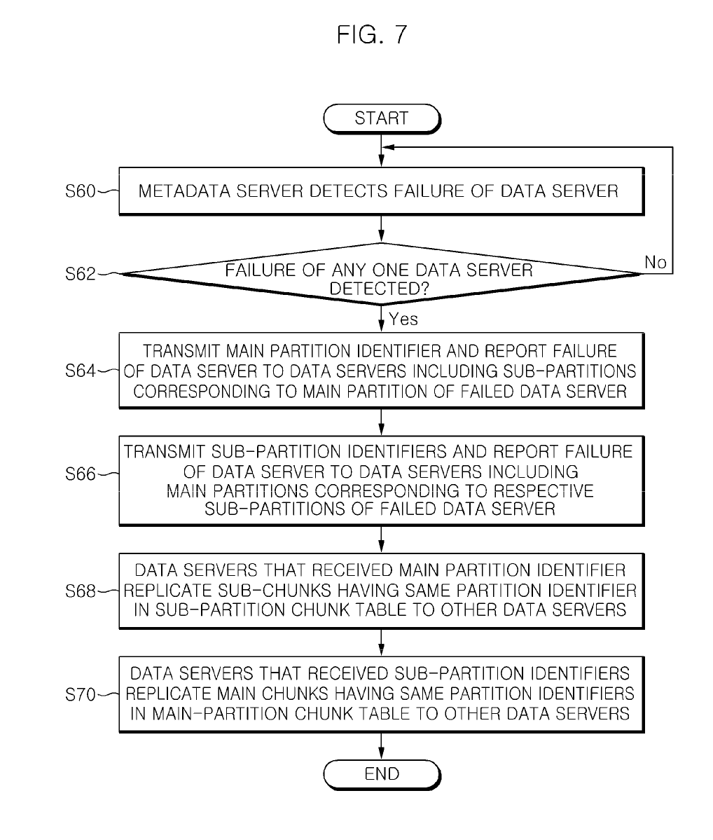

FIG. 7 is a flowchart showing a data recovery method in the asymmetric clustered distributed file system according to an embodiment of the present invention. In other words, FIG. 7 illustrates a flowchart showing a process for recovering data chunks stored in a failed data server using other data servers related to the failed data server when a failure is detected in the data server in the asymmetric clustered distributed file system to which the present invention is applied.

First, the metadata server 20 performs an operation of detecting the failure of the data server 32, 34 or 36 (refer to FIG. 3), which may occur due to various situations, such as a network failure or a hardware failure at step S60.

As a result, if the metadata server 20 detects the failure of, for example, the first data server 32 (in the case of “Yes” at step S62), the metadata server 20 transmits the partition information and failure occurrence message of the failed first data server 32 to other data servers, that is, the second and third data servers 34 and 36.

That is, the metadata server 20 reports the failure of the first data server 32 to the second and third data servers 34 and 36 which include sub-partitions 1 34b and 36b corresponding to the main partition 1 32a of the failed first data server 32 while transmitting a main partition identifier to the second and third data servers 34 and 36 at step S64.

Thereafter, the metadata server 20 reports the failure of the first data server 32 to the second and third data servers 34 and 36 which include main partitions 2 and 3 34a and 36a corresponding to the sub-partitions 2 and 3 32b and 32c of the failed first data server 32 while transmitting sub-partition identifiers to the second and third data servers 34 and 36 at step S66.

Accordingly, the second and third data servers 34 and 36 that received the main partition identifier of the failed first data server 32 replicate sub-chunks having the same partition identifier as the main partition identifier in the sub-partition chunk table to other data servers (data servers prepared separately from the first, second and third data servers, not shown) at step S68.

Further, the second and third data servers 34 and 36 that received the sub-partition identifiers of the failed first data server 32 replicate the main chunks to the sub-partitions of other data servers (data servers prepared separately from the first, second and third data servers, not shown) when the number of sub-chunks having the same partition identifier as each received sub-partition identifier in the main partition chunk table is less than the preset number of replicas at step S70.

According to the present invention having the above construction, when a failure occurs in a data server in an asymmetric clustered distributed file system, a failed partition is reported to all data servers including other partitions of a volume to which the partitions of the failed data server belong. Accordingly, other data servers can simultaneously perform the recovery of chunks using the information of their own main chunks and sub-chunks.

Therefore, when a failure occurs in a data server, all related data servers can simultaneously participate in data recovery, thus more promptly and efficiently coping with the failure.

Furthermore, the storage space of each data server is divided into main partitions and sub-partitions to enable the partitions to be managed based on relations therebetween, and main chunk information and sub-chunk information are separately stored and managed in the main partitions and the sub-partitions, thus efficiently performing the recovery of chunks.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A data replication method in an asymmetric clustered distributed file system, comprising:
storing data received from a client in a relevant main chunk, using a first data server which includes a main partition having the main chunk;
transmitting data stored in the main chunk to a second data server which includes a sub-partition having a sub-chunk corresponding to the main chunk, using the first data server; and
replicating the received data to the sub-chunk, using the second data server.

2. The data replication method as set forth in claim 1, wherein the first data server is divided into the main partition and a sub-partition corresponding to a main partition of the second data server.

3. The data replication method as set forth in claim 2, wherein the first data server comprises a main partition chunk table for managing information about a sub-chunk corresponding to the main chunk stored in the main partition, and a sub-partition chunk table for managing information about a main chunk corresponding to a sub-chunk stored in the sub-partition.

4. The data replication method as set forth in claim 3, wherein each of the main partition chunk table and the sub-partition chunk table comprises a partition identifier and a chunk identifier.

5. The data replication method as set forth in claim 4, wherein the partition identifier is a unique value assigned by a metadata server.

6. The data replication method as set forth in claim 4, wherein the chunk identifier comprises a file identifier of a file including a relevant chunk and an offset indicating an ordinal position of the relevant chunk within the file.

7. The data replication method as set forth in claim 1, wherein the second data server is divided into the sub-partition and a main partition having a main chunk differing from the main chunk of the first data server.

8. The data replication method as set forth in claim 1, wherein the second data server comprises a plurality of data servers.

9. The data replication method as set forth in claim 1, further comprising, transmitting information about the main chunk to the client using the first data server, as the main chunk is initially allocated by a metadata server.

10. The data replication method as set forth in claim 9, wherein the transmitting the main chunk information comprises registering the main chunk information in a main partition chunk table of the first data server.

11. The data replication method as set forth in claim 9, wherein the metadata server divides and manages an entire storage space on a volume basis so that, for each volume, a storage space of each of the first and second data servers is divided into a plurality of partitions.

12. The data replication method as set forth in claim 11, wherein the plurality of partitions divided for each volume comprises a main partition for storing a main chunk and a sub-partition corresponding to a main partition of another data server, for each of the first and second data servers.

13. The data replication method as set forth in claim 9, further comprising transmitting information about the sub-chunk corresponding to the main chunk to the first data server using the second data server, as the sub-chunk is initially allocated by the metadata server.

14. The data replication method as set forth in claim 13, wherein the transmitting the sub-chunk information comprises registering the sub-chunk information in a sub-partition chunk table of the second data server.

15. The data replication method as set forth in claim 1, further comprising:
when data is added to the main chunk or when data of the main chunk is updated, transmitting data identical to the added or updated data to the second data server, using the first data server; and
replicating the received data to the sub-chunk of the sub-partition using the second data server.

16. A data recovery method in an asymmetric clustered distributed file system, comprising:
replicating a sub-chunk of a sub-partition corresponding to a main partition of a failed data server to another data server, using a first data server which includes the sub-partition; and
replicating a main chunk of a main partition corresponding to the sub-partition of the failed data server to another data server, using a second data server which includes the main partition.

17. The data recovery method as set forth in claim 16, wherein the sub-chunk of the sub-partition has a partition identifier identical to a main partition identifier of the failed data server.

18. The data recovery method as set forth in claim 16, wherein the main chunk of the main partition has a partition identifier identical to a sub-partition identifier of the failed data server.

19. The data recovery method as set forth in claim 16, wherein the replicating the main chunk is configured to replicate the main chunk to other data servers until the number of replicas of the main chunk becomes identical to a preset number of replicas.
